(19) United States
(12) Patent Application Publication
(10) Pub. No.: US 2025/0251912 A1
(43) Pub. Date: Aug. 7, 2025

(54) SYSTEMS AND METHODS FOR A MULTILANGUAGE WEB DEVELOPMENT STACK WITH CONFIGURABLE INTERFACE

(71) Applicant: BANK OF AMERICA CORPORATION, Charlotte, NC (US)

(72) Inventors: Wasil Salim Shaikh, Mumbai (IN); Vasant Gawade, Mumbai (IN); Pradumna Ramakant Dube, New Delhi (IN)

(73) Assignee: BANK OF AMERICA CORPORATION, Charlotte, NC (US)

(21) Appl. No.: 18/432,981

(22) Filed: Feb. 5, 2024

(51) Int. Cl. G06F 8/30

(52) U.S. Cl. CPC G06F 8/31

(57) ABSTRACT

Systems, computer program products, and methods are described herein for a multilanguage web development stack with a configurable interface. The present disclosure is configured to streamline the development process by enabling the simultaneous use of multiple programming languages within a single integrated development environment (IDE). This configuration allows for the seamless creation, management, and deployment of web applications. By incorporating a user-friendly admin interface, developers can set project-specific parameters, access a repository of language-specific tools and libraries, and manage the lifecycle of the application through intuitive graphical or command-line interfaces. The system also includes a middleware component for orchestrating interactions between the multilanguage codebase and external services, ensuring a cohesive workflow from development to deployment. This innovative approach reduces complexity and enhances productivity, catering to the diverse needs of modern web development teams.

### TECHNOLOGICAL FIELD

Example embodiments of the present disclosure relate to a multilanguage web development stack with configurable interface.

### BACKGROUND

In the dynamic and evolving field of web application development, the industry faces several pressing challenges that hinder efficiency and innovation. A primary concern is the necessity for developers to learn a diverse range of skills across various programming languages and technologies. This multiplicity of skills is challenging for individuals to acquire and maintain, often resulting in a skill gap. Additionally, when working in teams or organizations, developers come with different skillsets and expertise. The coordination of these varied skills for a unified web application development process can be inefficient, leading to potential project bottlenecks. This issue is compounded by the inherent slowness of the development process; even seasoned software engineers typically spend months developing web applications to ensure they are robust and production-ready.

A significant part of this inefficiency stems from limitations in existing web framework libraries, which often lack essential features for seamless integration and utilization of multiple programming languages. This gap in functionality leads to increased development time and resource allocation, impacting the overall productivity and cost-effectiveness of organizations. Recognizing these challenges, there is a clear need for an innovative solution that streamlines the web application development process. Such a solution would enable developers to leverage their existing programming skills more effectively, providing a comprehensive suite of tools and components for web development. Ideally, this solution would facilitate the integration and hosting of multiple programming languages within a single, unified codebase. By doing so, it would significantly speed up the development process, reduce the learning curve for developers, and save immense time within organization by accelerating web application development.

As such, Applicant has identified a number of deficiencies and problems associated with a multilanguage web development stack with configurable interface. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for a multilanguage web development stack with configurable interface. The proposed technical solution addresses the complexities and inefficiencies in web application development by extending the Model-View-Controller (MVC) framework. This extension involves the creation of two foundational layers: the concurrence multilanguage base layer and the intelligent assimilations API layer. The multilanguage base layer includes a stack of various programming languages such as Python, Java, and PHP. Each language stack is equipped with built-in methods for UI components, utilizing Jinja templates and ReactJS library for dynamic rendering. Developers can create user interface (UI) workflows using language-specific packages, which are then deployed as HTML templates in a middleware database accessible through an admin interface.

The intelligent assimilations API layer acts as a tool to represent these UI workflows as HTML templates, irrespective of the programming language used. This layer employs an API to render these templates as a seamless and integrated user interface for customers. Additionally, custom-built libraries and packages support runtime input/output feeds, enhancing the developer experience. Advanced techniques and technologies such as APIs for efficient data exchange, multi-processing to run each web application independently to avoid conflicts, and a microservice architecture to host multi-language applications under a unified portal are integral parts of this solution.

This innovative approach promises to revolutionize the efficiency and effectiveness of web application development, offering a significant reduction in development time and resources. By enabling the use of any programming language within a unified framework, it opens up new possibilities for developers and organizations, streamlining the development process and fostering innovation in web applications.

As such, embodiments of the invention relate to systems, methods, and computer program products for automated mesh service-based deployment intelligence, the invention generally including the steps of: initiate an admin interface to configure multiple aspects of a web application; generate a document comprising guidelines for development of the web application; generate a project codebase comprising code in multiple selected programming languages as specified by system settings and application settings; download and integrate a Model-View-Controller (MVC) Representational State Transfer (REST) framework and executables for a subset of the multiple selected programming languages into a development stack; further define the system settings and the application settings for the web application based on the subset of the multiple selected programming languages via including database connections and service endpoints; and deploying the web application via a user device accessible to a user.

In some embodiments, the invention is further configured to provide an administrative interface enabling a configuration of environmental variables and management of project dependencies.

In some embodiments, the admin interface further comprises a graphical user interface managing permissions and tool-specific configurations within the development stack.

In some embodiments, the invention is further configured to interface with a middleware component, wherein the middleware component manages calls to external web services and external resources.

In some embodiments, the invention is further configured to provide a selection option, via the web application, for a base language and a selection option for corresponding language-specific executables.

In some embodiments, the invention is further configured to perform a code quality and security scan of a project codebase, comprising validating the project codebase against predefined coding standards.

In some embodiments, the code scan further comprises static code analysis for vulnerabilities and adherence to coding standards prior to deploying the web application.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for a multilanguage web development stack with configurable interface, in accordance with an embodiment of the disclosure;

FIG. 2 illustrates an architecture diagram 200 for a multilanguage web development stack with configurable interface, in accordance with an embodiment of the disclosure;

FIG. 3 illustrates a process flow 300 for a multilanguage web development stack with configurable interface, in accordance with an embodiment of the disclosure; and

FIG. 4 illustrates a tool workflow 400 for a multilanguage web development stack with configurable interface, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

The technology presented herein introduces a novel approach to web application development. It integrates a versatile, multilanguage web development stack within a configurable interface, streamlining the process of creating web applications. This innovative system leverages the robustness of Model-View-Controller (MVC) frameworks, such as Django and Spring, and enhances them with a unique two-layered approach, accommodating multiple programming languages and seamless frontend-backend integration. The field of web application development faces significant challenges, including the requirement for diverse skill sets, inefficiencies in team coordination, and prolonged development cycles. Traditional web frameworks often lack the flexibility to seamlessly integrate multiple programming languages, leading to bottlenecks in development processes and limitations in utilizing diverse programming expertise.

The solution provided by this technology is akin to a universal translator for web development languages. It enables developers to use their preferred programming language within a unified framework to create web applications. This approach democratizes web development, allowing for a broader range of programmers to contribute effectively, regardless of their specific language expertise. The system simplifies the development process, making it faster and more efficient, while maintaining high standards of performance and functionality.

Accordingly, the present disclosure offers a comprehensive solution to the challenges in web application development. This includes a multilanguage base layer that allows for the concurrent use of multiple programming languages within a single MVC framework. An intelligent API layer provides a seamless interface for these diverse languages, ensuring a unified and efficient user experience. The system also utilizes advanced technologies like multiprocessing and microservice architecture to optimize performance and scalability. This innovative approach not only accelerates the development process but also significantly reduces the resources required, such as full-time employee involvement and computing power.

What is more, the present disclosure provides a technical solution to a technical problem. As described herein, the technical problem includes the inefficiency and limitations of current web development frameworks in handling multiple programming languages and the complexity of integrating various skill sets in a team. The technical solution presented allows for streamlined, language-agnostic web application development. It solves these problems by introducing a multilanguage base layer that supports various programming languages within a unified MVC framework, and an intelligent API layer that facilitates seamless integration of these languages. This solution offers a more efficient, resource-saving approach to web development, reducing the need for extensive manual input, decreasing network traffic, and optimizing the use of computing resources. Moreover, this technical solution employs a rigorous, computerized process that eliminates redundant steps in the development process, thereby conserving additional resources and enhancing overall efficiency.

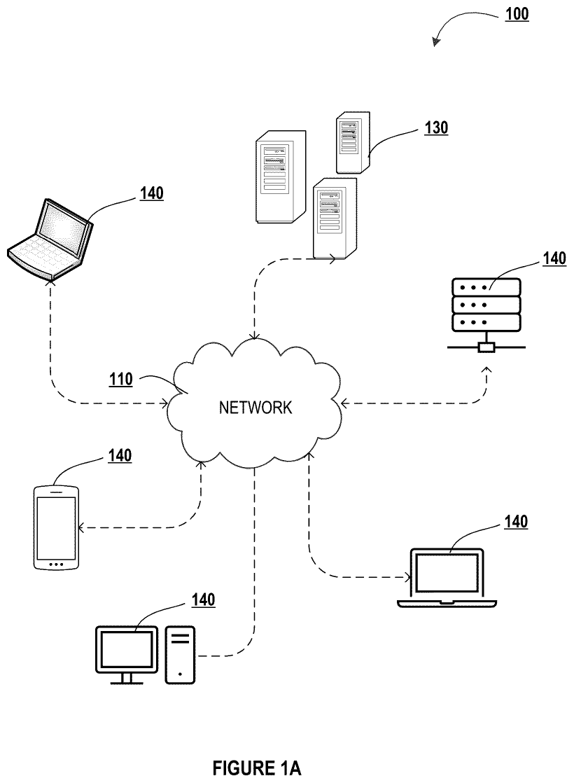

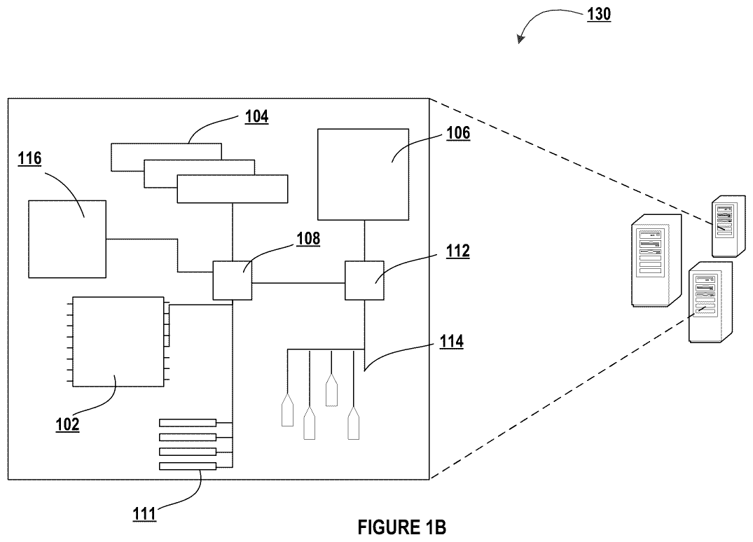

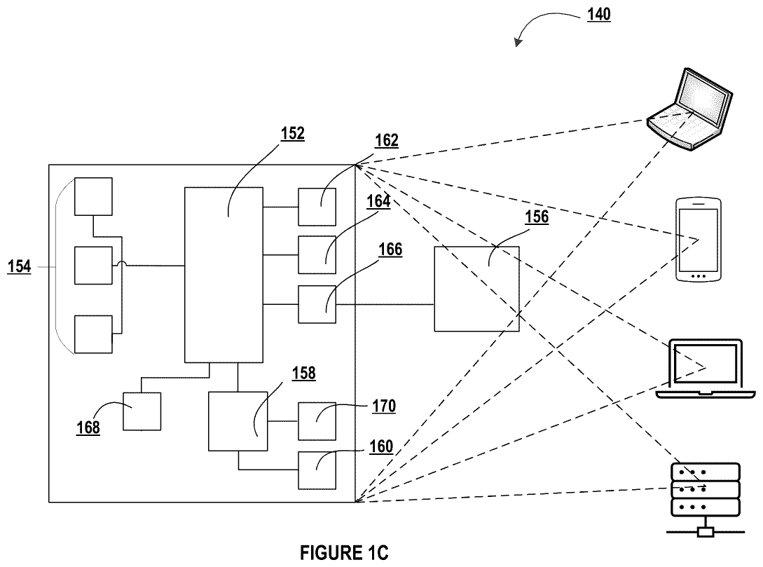

FIGS. 1A-1C illustrate technical components of an exemplary distributed computing environment 100 for a multilanguage web development stack with configurable interface, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

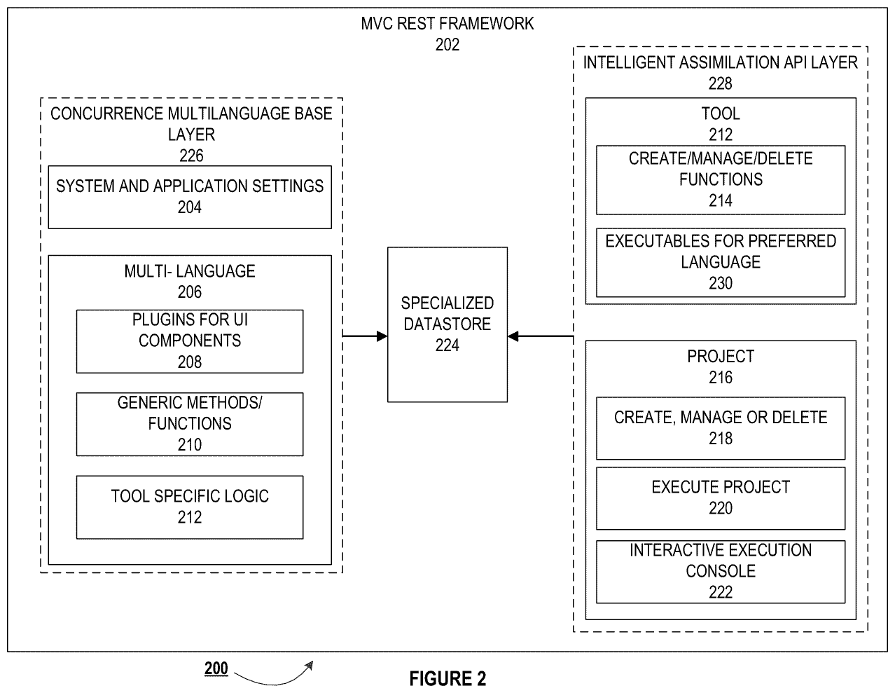

FIG. 2 illustrates an architecture diagram 200 for a multilanguage web development stack with a configurable interface, in accordance with an embodiment of the disclosure. The proposed web development stack significantly enhances the functionality of the traditional Model-View-Controller (MVC) framework by introducing a robust admin interface capable of handling web applications developed in any programming language. This advanced interface serves as the entry point for developers to create, configure, and manage web applications with ease, providing a flexible platform that supports a wide range of development needs.

To achieve this flexibility, it is understood that an existing framework may be augmented with a comprehensive directory structure meticulously designed to support multiple programming languages. This structure acts as the backbone of the development environment, enabling the simultaneous use and management of various languages within a single project. For each supported programming language, dedicated configuration files are established. In some embodiments, these configuration files adopt standard formats such as YAML, INI, or ENV, which are widely recognized for their simplicity and effectiveness in managing configuration settings. Users and developers may utilize these files to define and manage essential variables, particularly those related to storage such as database connections and codebase paths. It is understood that this approach not only streamlines the configuration process but also introduces a level of standardization across the development stack, ensuring consistency and reliability in application deployment.

In some embodiments, the extension of the admin interface includes the integration of two distinct models. The first model caters to tools, which represent the web applications themselves. This model maintains crucial information including the applications name, the executables associated with specific programming languages, and logs that track the application's performance and usage. The second model focuses on projects, representing the customer side of the development process. In some embodiments the second model stores interaction details, datasets related to input and output, and logs that provide insights into project interactions and history.

To accommodate the generation and management of web elements within the admin interface, a class structure may be established in some embodiments for each programming language within the directory framework. These classes are designed to come equipped with methods and functions specifically designed to generate web elements, integrate necessary JavaScript libraries for enhanced functionality, and handle the intricacies of input/output interactions. This structured approach provides a standardized yet customizable way to build and manage the UI components across different programming languages.

It is understood that deployment of these components is streamlined through the middleware database tool models. This integration ensures that the components are not only stored securely but are also readily accessible for further development and integration into the web applications. One of ordinary skill in the art will appreciate that the admin interface empowers developers to innovate with increased efficiency and adaptability. In utilizing the present invention, developers have the capability to create new tools by extending the predefined programming-specific classes. Through this inheritance, they can design intricate and tailored user interfaces that meet specific application requirements. In some embodiments, once designed, these interfaces may be stored as templates within the middleware database, ready to be deployed or further refined, which exemplifies the system's ability in providing a seamless and efficient development experience, from initial creation to final deployment.

As shown in FIG. 2, the architecture of the present invention integrates an MVC REST framework 202 with a concurrence multilanguage base layer 226 and an intelligent assimilation API layer 228, facilitating a versatile and dynamic web development environment. Within the concurrence multilanguage base layer 226, system and application settings 204 provide a configurable foundation for the development stack, allowing adjustments and optimizations tailored to diverse project requirements. Multi-language 206 capabilities enable the system to support various programming languages, thus accommodating a broad spectrum of developer expertise and preferences. For instance, a developer could leverage these settings to switch between SQL and NoSQL databases depending on the project's data handling requirements, or the like.

The multi-language 206 capabilities of the base layer 226 support various programming languages, thereby accommodating developers with differing levels of expertise and preferences. In some embodiments, this could enable a Python developer to work on backend components, while a JavaScript expert could simultaneously develop the frontend, all within the same integrated development environment. To further enhance user interface development, plugins for UI components 208 are employed, which take advantage of resources such as Jinja templates and ReactJS libraries to create dynamic and responsive UI designs. For example, a plugin might allow the rapid integration of a ReactJS component into a Jinja-based template, streamlining the development of a feature-rich web application.

The inclusion of generic methods/functions 210 within the base layer 226 offers standardized coding procedures that can streamline development across different programming languages within the stack. In some embodiments, this might include a generic authentication function that can be called regardless of whether the underlying codebase is written in PHP or Ruby, thus simplifying the process of securing web applications, or the like. Furthermore, the tool specific logic 212 allows for the customization of processes unique to the development tools in use, thereby optimizing the development workflow and increasing efficiency.

In some embodiments, this manifests as a suite of diagnostic tools that are automatically tailored to the language and libraries being used, providing developers with real-time feedback and error logging specific to their development context. It is understood that this tool-specific customization is not only an enhancement but an essential component for projects with unique operational requirements, such as those requiring specialized data encryption or real-time data processing features.

As depicted on the right side of FIG. 2, in some embodiments, the intelligent assimilation API layer 228 operates to interface seamlessly with a specialized datastore 224. This interface translates diverse data structures and operations into a unified format, thereby simplifying the complexities involved in the storage and retrieval processes. For example, the API layer 228 may take JSON data from a Node.js application and XML data from a Java application, and store both in a unified format within the specialized datastore 224, or the like. The intelligent assimilation API layer 228 further simplifies the development process by incorporating a tool 212 for creating, managing, and deleting functions 214. This allows developers to streamline their interactions with system components, for instance, by providing a unified function call that abstracts away the language-specific details of database access or user authentication.

Additionally, the intelligent assimilation API layer 228 includes executables for preferred language 230, enabling developers to write code in the programming language with which they are most comfortable, thus mitigating compatibility concerns. For instance, a developer may write data processing logic in Python while another writes in JavaScript, both of which are then executed within the same system architecture without conflict, or the like. This functionality is supported by a project 216 management component that enables the creation, management, or deletion 218 of projects within the framework. An executable project 220 feature and an interactive execution console 222 are also provided, which not only facilitate the execution of projects in real-time but also significantly enhance the development experience by enabling immediate problem identification. For example, a developer might use the interactive execution console 222 to perform live debugging of a web service, editing and testing code on-the-fly directly within the admin interface.

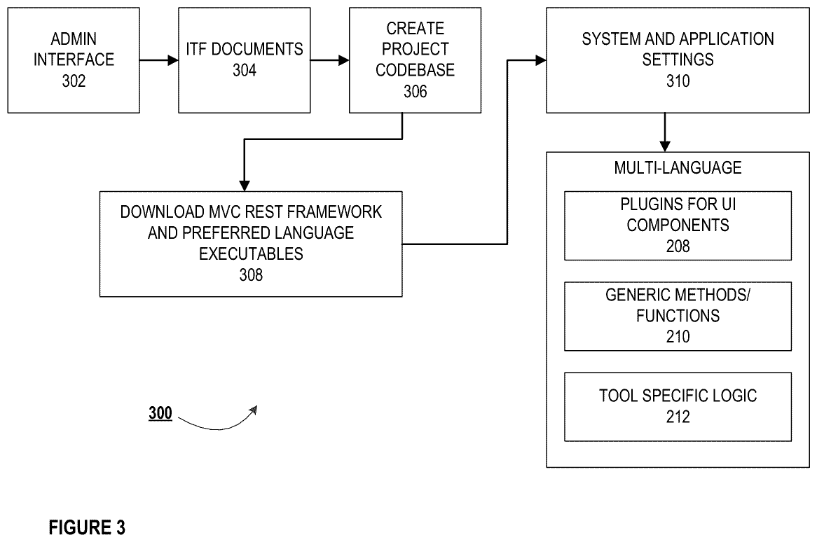

FIG. 3 illustrates a process flow 300 for a multilanguage web development stack with configurable interface, in accordance with an embodiment of the disclosure. In some embodiments, the flow methodically outlines the progression through different components and actions that are instrumental in the development and management of web applications within a multilingual environment. For instance, this process may be initiated through a command-line interface or a graphical user interface that allows developers to select and manage multiple programming languages, allowing extensions for different language support.

At the beginning of the process, the admin interface 302 acts as the primary interaction point. In some embodiments, developers might utilize this interface in a manner similar to configuring a build system, or the like, where the foundational aspects of a web application such as dependencies, build directory, and plugin configurations are defined. This interface orchestrates the subsequent steps, ensuring that the development process complies with the parameters and settings specified by the developer, which may include language version selection, framework choices, and other toolchain configurations, or the like.

Subsequent to the initial configuration within the admin interface 302, interface technical framework (ITF) documents 304 are generated. In certain embodiments, these documents may include manifest files or README documentation that detail the development guidelines, coding standards, and architectural decisions. They serve as a comprehensive blueprint for developers, much like a technical specification document, guiding the construction of a coherent and functional web application. The ITF documents 304 ensure all components and activities are aligned with the project's objectives and adhere to its technical requirements, from the backend logic written in Java to the frontend aesthetics.

In some embodiments, the development process follows the guidelines provided by the ITF documents 304 to initiate the create project codebase 306 step. This fundamental phase entails the actual coding and compilation of the project codebase, establishing the structural bedrock for the web application. For instance, in some embodiments, a developer might utilize a polyglot programming approach to craft the codebase, combining Java for backend services with Swift for other specific functionalities, all within a unified development environment that supports these languages as dictated by the system and application settings 310.

In parallel to the establishment of the project codebase 306, the process includes downloading the MVC REST framework 202 and preferred language executables 308. In certain embodiments, this might involve retrieving a specific version of the Django framework for Python development, or the Express framework in a Node.js environment, or the like, ensuring that the chosen frameworks and language executables are synchronized with the project's specifications. This step is akin to using a package manager, or the like, to pull in the necessary dependencies and executable environments that align with the developer's preferred programming language, thereby facilitating their integration into the development stack.

As the process flow 300 continues, it transitions to refining the system and application settings 310. In some embodiments, this involves specifying configurations much like setting up a .env file in a Node.js project to manage environment variables, or configuring a web.xml file in a Java Servlet-based application to define servlet parameters and mappings. These settings 310 might encompass establishing database connections depending on the application, defining RESTful service endpoints, and setting language-specific parameters such as compiler flags or interpreter versions. One of ordinary skill in the art will appreciate that defining such a configuration is vital to ensuring the seamless operation and integration of multilanguage support within the stack, allowing for a robust and versatile development ecosystem.

Lastly, the flow culminates with the multi-language 206 integration, where plugins for UI components 208, generic methods/functions 210, and tool specific logic 212 are employed. This integration allows developers to utilize a suite of pre-built components and logic to expedite the development process while ensuring consistency and quality across different programming languages used within the project. For example, a plugin for UI components 208 could enable a developer to insert an interactive chart into the application without writing extensive JavaScript code, instead using a predefined component that can be easily configured and styled through the admin interface 302.

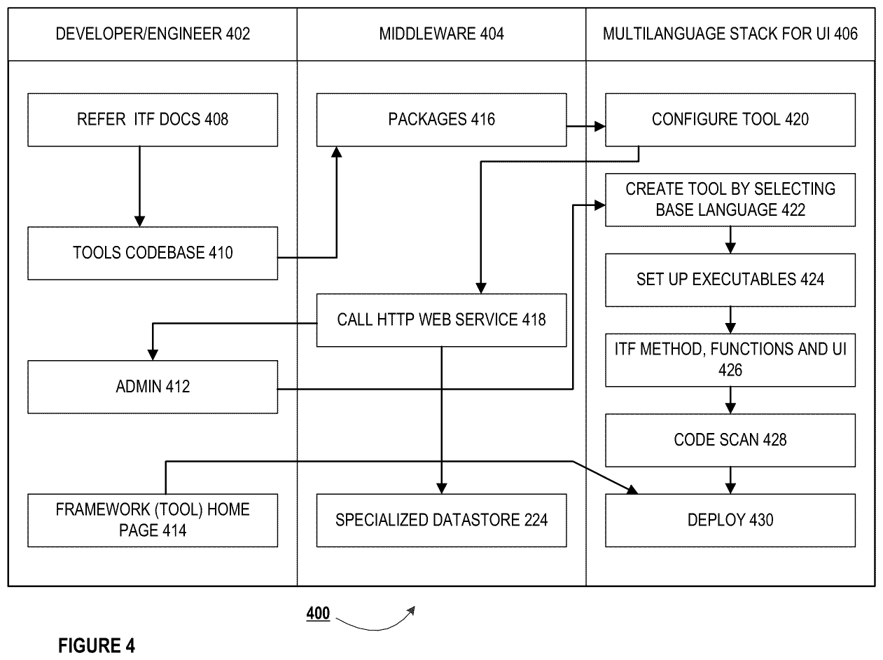

FIG. 4 illustrates a tool workflow 400 for a multilanguage web development stack with configurable interface, in accordance with an embodiment of the disclosure. FIG. 4 illustrates a tool workflow 400 for a multilanguage web development stack with a configurable interface, in accordance with an embodiment of the disclosure. This workflow provides a comprehensive overview of the steps and components involved in developing and managing tools within the web development stack.

The workflow begins with a developer or engineer 402 who initiates the development process. The first step involves referring to ITF documents 408, which contain the specifications and guidelines necessary for the development of the tool. It is understood that these documents serve as the roadmap, outlining the necessary standards and practices to be followed throughout the development lifecycle. In the architecture of the disclosed multilanguage web development stack, ITF documents play a pivotal role in ensuring that the system components are cohesively designed and implemented. These documents, typically known as Interface Definition Documents, Implementation Technical Files, or Interface Design Documents, serve as comprehensive blueprints for the software development lifecycle. Interface Definition Documents provide detailed specifications for application programming interfaces (APIs), data formats, and protocol interfaces, which are essential for facilitating communication between disparate software components, modules, or systems. They detail the contractual agreements between various system interfaces, specifying how web services should handle requests and structure the responses, thereby enabling interoperability and ensuring consistent behavior across the system.

Implementation Technical Files contain the in-depth technical specifications and guidelines necessary for the precise implementation of system features or components. In some embodiments, these documents may encompass a range of critical information including coding standards, architectural diagrams, function definitions, and other technical details that guide developers in constructing features that align with the overarching system design and objectives. Interface Design Documents outline the user interface design and interaction between different service layers within the system. These documents are instrumental in defining the layout, user interaction flows, and visual consistency of the user interface, thereby ensuring an intuitive and seamless user experience. They provide guidelines on interface aesthetics, usability, and functionality, which are crucial for user engagement and satisfaction, or the like.

In some embodiments, following the guidance of the ITF documents 408, the developer embarks on the construction of the tool by accessing the tools codebase 410. This repository is not merely a collection of code snippets but a comprehensive library of resources, complete with developmental history and version control. Within this codebase, developers are empowered to write and revise code, leveraging the multilanguage capabilities of the stack. For instance, a developer might use the codebase 410 to integrate a Python-based data processing tool with a frontend developed in JavaScript, all the while ensuring that the multilanguage architecture provides seamless interoperability between these disparate languages.

Upon establishing a solid foundation within the tools codebase 410, the developer engages with the admin 412 component. In some embodiments, the admin 412 provides a graphical user interface that allows developers to execute a variety of administrative tasks with ease and precision. Through this interface, a developer could configure tool settings, akin to setting environmental variables in a Docker container, or manage permissions, similar to defining roles within an cloud identity and access management (IAM) policy. Moreover, managing dependencies through the admin 412 could resemble utilizing a package manager, or the like, to ensure that all necessary libraries are included and maintained. This admin 412 component acts as a central hub for the configuration and management of the tools being developed, ensuring that each tool is tailored to meet its specific operational needs and integrated within the larger ecosystem of the web development stack.

In some embodiments, after the completion of the administrative tasks through the admin 412, the developer signals the tool's readiness by deploying it to the framework's (tool) home page 414. This crucial step transitions the tool from the development phase to being operational and available to end-users. For example, akin to deploying a web application on platforms like Heroku or the like, the tool's deployment to the home page 414 signifies that it has passed all necessary pre-deployment checks and is now live for user interaction, marking the end of its initial setup phase.

Concurrently, the middleware 404 serves as a conduit between the tool and its operational components. It interfaces with packages 416, which may encompass integrating third-party SDKs for enhanced analytics or authentication features within the tool, or the like. Additionally, the middleware 404 manages calls to the HTTP web service 418, facilitating communication with external services and APIs. This could be comparable to invoking RESTful services or sending GraphQL queries from the tool to external web resources, ensuring that data flow and external interactions are maintained as per the tool's functional requirements.

Meanwhile, another essential workflow occurs within the multilanguage stack for UI 406. Here, developers engage in configuring the tool 420 by selecting the base language 422 for the tool's development, such as choosing between Python, Java, or JavaScript based on the project needs and the team expertise. This selection dictates the programming environment, influencing factors like syntax, libraries, and runtime behavior, much like setting up a project's language-specific environment using Docker containers, or the like. Upon this selection, developers may then set up the executables 424, ensuring that the chosen language's runtime and compiler are ready for use. Subsequent to these configurations, ITF method, functions, and UI 426 are established, which detail the operational logic and user interface elements specific to the tool, similar to defining endpoints in a Swagger API documentation or setting up routes in a React application. These definitions are instrumental in guiding the development process, ensuring that the tool adheres to the prescribed functionalities and user interface specifications.

In some embodiments, following the ITF configurations, a code scan 428 is conducted, which acts as an automated check, ensuring the integrity and security of the code before it progresses to deployment, or the like. This code scan 428 may be analogous to running a suite of static code analysis tools, such as SonarQube or Fortify, which meticulously evaluate the code against a predefined set of quality and security criteria. It examines the code for common vulnerabilities like SQL injection, cross-site scripting, and improper error handling, as well as checks for adherence to coding standards that could include formatting, commenting, and proper use of constructs and data types. Only when the codebase successfully passes through the code scan 428, verifying that the code is robust, secure, and maintainable, is the tool deemed ready for deployment 430. At this stage, similar to passing a continuous integration pipeline, the tool can be merged into the main branch of the project repository and becomes a candidate for release, ready to be operationalized within the web development stack and accessible to the intended end-users or queued for further development and enhancement cycles.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for a multilanguage web development stack with configurable interface, the system comprising:
a processing device;
a non-transitory storage device containing instructions when executed by the processing device, causes the processing device to perform the steps of:
initiating an admin interface to configure multiple aspects of a web application;
generating a document comprising guidelines for development of the web application;
generating a project codebase comprising code in multiple selected programming languages as specified by system settings and application settings;
downloading and integrating a Model-View-Controller (MVC) Representational State Transfer (REST) framework and executables for a subset of the multiple selected programming languages into a development stack;
further defining the system settings and the application settings for the web application based on the subset of the multiple selected programming languages via including database connections and service endpoints; and
deploying the web application via a user device accessible to a user.

2. The system of claim 1, wherein the system is further configured to: provide an administrative interface enabling a configuration of environmental variables and management of project dependencies.

3. The system of claim 2, wherein the admin interface further comprises a graphical user interface managing permissions and tool-specific configurations within the development stack.

4. The system of claim 1, wherein the system is further configured to: interface with a middleware component, wherein the middleware component manages calls to external web services and external resources.

5. The system of claim 1, wherein the system is further configured to: provide a selection option, via the web application, for a base language and a selection option for corresponding language-specific executables.

6. The system of claim 1, wherein the system is further configured to: perform a code quality and security scan of a project codebase, comprising validating the project codebase against predefined coding standards.

7. The system of claim 6, wherein the code scan further comprises static code analysis for vulnerabilities and adherence to coding standards prior to deploying the web application.

8. A computer program product for a multilanguage web development stack with configurable interface, the computer program product comprising a non-transitory computer-readable medium comprising code causing an apparatus to:
initiate an admin interface to configure multiple aspects of a web application;
generate a document comprising guidelines for development of the web application;
generate a project codebase comprising code in multiple selected programming languages as specified by system settings and application settings;
download and integrate a Model-View-Controller (MVC) Representational State Transfer (REST) framework and executables for a subset of the multiple selected programming languages into a development stack;
further define the system settings and the application settings for the web application based on the subset of the multiple selected programming languages via including database connections and service endpoints; and
deploying the web application via a user device accessible to a user.

9. The computer program product of claim 8, further causing an apparatus to: provide an administrative interface enabling a configuration of environmental variables and management of project dependencies.

10. The computer program product of claim 9, wherein the admin interface further comprises a graphical user interface managing permissions and tool-specific configurations within the development stack.

11. The computer program product of claim 8, further causing an apparatus to: interface with a middleware component, wherein the middleware component manages calls to external web services and external resources.

12. The computer program product of claim 8, further causing an apparatus to: provide a selection option, via the web application, for a base language and a selection option for corresponding language-specific executables.

13. The computer program product of claim 8, further causing an apparatus to: perform a code quality and security scan of a project codebase, comprising validating the project codebase against predefined coding standards.

14. The computer program product of claim 13, wherein the code scan further comprises static code analysis for vulnerabilities and adherence to coding standards prior to deploying the web application.

15. A method for a multilanguage web development stack with configurable interface, the method comprising:
initiating an admin interface to configure multiple aspects of a web application;
generating a document comprising guidelines for development of the web application;
generating a project codebase comprising code in multiple selected programming languages as specified by system settings and application settings;
downloading and integrating a Model-View-Controller (MVC) Representational State Transfer (REST) framework and executables for a subset of the multiple selected programming languages into a development stack;
further defining the system settings and the application settings for the web application based on the subset of the multiple selected programming languages via including database connections and service endpoints; and
deploying the web application via a user device accessible to a user.

16. The method of claim 15, wherein the method further comprises: provide an administrative interface enabling a configuration of environmental variables and management of project dependencies.

17. The method of claim 16, wherein the admin interface further comprises a graphical user interface managing permissions and tool-specific configurations within the development stack.

18. The method of claim 15, wherein the method further comprises: interface with a middleware component, wherein the middleware component manages calls to external web services and external resources.

19. The method of claim 15, wherein the method further comprises: provide a selection option, via the web application, for a base language and a selection option for corresponding language-specific executables.

20. The method of claim 15, wherein the method further comprises: perform a code quality and security scan of a project codebase, comprising validating the project codebase against predefined coding standards.
